(19) United States
(12) Patent Application Publication
(10) Pub. No.: US 2004/0122171 A1
(43) Pub. Date: Jun. 24, 2004

(54) Hydrolysis resistant polyesters and articles made therefrom

(76) Inventor: William E. Garrison, Albuquerque, NM (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/183,929

(22) Filed: Jun. 26, 2002

Related U.S. Application Data
(60) Provisional application No. 60/302,146, filed on Jun. 29, 2001.

(51) Int. Cl. C08F 8/00

(52) U.S. Cl. 525/107

(57) ABSTRACT

Polyester composition comprising at least one polyester; and an epoxy system comprising diphenolic epoxy condensation polymer, and at least one epoxy compound comprising at least two epoxy groups per molecule of the epoxy compound(s). Articles made from these compositions, particularly articles requiring excellent hydrolysis resistance properties.

### CROSS-REFERENCE TO RELATED APPLICATION

This application claims the benefit of U.S. Provisional Application No. 60/302,146, filed Jun. 29, 2001.

### FIELD OF INVENTION

The field of invention relates to thermoplastic polyesters, and in particular, to hydrolysis resistant thermoplastic polyesters.

### BACKGROUND OF INVENTION

Increasing requirements for hydrolysis resistance of polyesters, especially those requirements proposed by the automotive industry, have made it increasingly important to be able to provide thermoplastic polyester compositions having even better resistance to hydrolysis compared to currently available compositions or those described in the existing art.

Hydrolysis resistance of thermoplastic polyesters can be improved by the addition of an epoxy material. However, when incorporated at the high levels necessitated by current hydrolysis resistant requirements, an epoxy material often has the disadvantage of increasing melt viscosity or even increasing the rate of viscosity increase during melt processing, both of which are detrimental to performance in melt fabrication operations such as injection molding.

Japanese Patent Application No. 09208816 A discloses a composition containing, inter alia, polyester resin (particularly of the ethylene terephthalate type), a compound containing at least two epoxy groups and/or an epoxy resin, and carbon black. However, this reference does not specifically disclose in any of the examples the use of both an epoxy resin and epoxy compound, does not disclose the relative ratios of epoxy resin to epoxy compound, if both are to be used, and does not disclose improved hydrolysis resistance when using both.

U.S. Pat. No. 5,596,049 discloses a composition containing, inter alia, linear polyester and difunctional epoxy compounds, particularly those having at least one of the epoxides on a cyclohexane ring. A potential drawback to using cyclohexane ring-based epoxides, however, is the high volatility of such epoxides that are currently available.

It is desirable to obtain a polyester composition that has improved hydrolysis resistant properties while avoiding the above-described drawbacks.

### SUMMARY OF INVENTION

My invention includes polyester compositions comprising (a) at least one polyester; and (b) an epoxy system comprising (i) diphenolic epoxy condensation polymer; and (ii) at least one epoxy compound comprising at least two epoxy groups per molecule of said at least one epoxy compound. Also included are articles made from such compositions.

### BRIEF DESCRIPTION OF DRAWINGS

FIG. 1 is a graph setting forth percent retention data of tensile strength and elongation after the pressure cooker test for Examples 1-5.

FIG. 2 is a graph setting forth melt viscosity and viscosity ratio data for Examples 1-5.

### DETAILED DESCRIPTION OF PREFERRED EMBODIMENTS

Polyester compositions of my invention comprise (a) at least one polyester; and (b) an epoxy system comprising (i) diphenolic epoxy condensation polymer and (ii) at least one epoxy compound comprising at least two epoxy groups per molecule of the epoxy compound.

Polyester

Polyester compositions of my invention comprise at least one polyester. The term “polyester” as used herein preferably includes polymers which are, in general, linear saturated condensation products of glycols and dicarboxylic acids, or reactive derivatives thereof. Preferably, polyesters comprise condensation products of aromatic dicarboxylic acids having 8 to 14 carbon atoms and at least one glycol selected from the group consisting of neopentyl glycol, cyclohexane dimethanol and aliphatic glycols of the formula HO(CH₂)ₙOH where n is an integer of 2 to 10. Up to 50 mole percent of the aromatic dicarboxylic acids can be replaced by at least one different aromatic dicarboxylic acid having from 8 to 14 carbon atoms, and/or up to 20 mole percent can be replaced by an aliphatic dicarboxylic acid having from 2 to 12 carbon atoms.

A high molecular weight polyester can be obtained preferably by solid state polymerization of a lower molecular weight polyester obtained by melt condensation.

Preferred polyesters include polyethylene terephthalate; poly( 1,4-butylene) terephthalate; 1,4-cyclohexylene dimethylene terephthalate; 1,4-cyclohexylene dimethylene terephthalate/isophthalate copolymer; and other linear homopolymer esters derived from aromatic dicarboxylic acids and glycols. Preferred aromatic dicarboxylic acids include isophthalic; bibenzoic; naphthalane-dicarboxylic including the 1,5-,2,6-, and 2,7-naphthalenedicarboxylic acids; 4,4′diphenylenedicarboxylic acid; bis(p-carboxyphenyl) methane; ethylene-bis-p-benzoic acid; 1,4-tetramethylene bis(p-oxybenzoic) acid; ethylene bis(p-oxybenzoic) acid; and 1,3-trimethylene bis(p-oxybenzoic) acid. Preferred glycols include those selected from the group consisting of 2,2-dimethyl-1,3-propane diol; cyclohexane dimethanol; and aliphatic glycols of the general formula HO(CH₂)ₙOH where n is an integer from 2 to 10, e.g., ethylene glycol; 1,3-trimethylene glycol; 1,4-tetramethylene glycol; 1,6-hexamethylene glycol; 1,8-octamethylene glycol; 1,10-decamethylene glycol; 1,3-propylene glycol; and 1,4-butylene glycol. Up to 20 mole percent, as indicated above, of preferably adipic, sebacic, azelaic, dodecanedioic acid or 1,4-cyclohexanedicarboxylic acid can be present.

More preferred polyesters are based on polyethylene terephthalate homopolymers, polybutylene terephthalate homopolymers, polyethylene terephthalate/polybutylene terephthalate copolymers, polyethylene terephthalate copolymers, polyethylene terephthalate/polybutylene terephthalate mixtures and/or mixtures thereof, although any other polyesters can be used as well, either alone or in any combination with any of the polyesters described herein. Even more preferred as the polyester is polybutylene terephthalate which has not been solid state polymerized.

Epoxy System

Polyester compositions of my invention also comprise an epoxy system comprising (i) diphenolic epoxy condensation polymer (“first part of the epoxy system”) and (ii) at least one epoxy compound comprising at least two epoxy groups per molecule of the epoxy compound (“second part of the epoxy system”).

Regarding the first part of the epoxy system, as used herein, “diphenolic epoxy condensation polymer” means a condensation polymer having epoxy functional groups, preferably as end groups, and a diphenol moiety within the polymer. Such diphenolic epoxy condensation polymers are well-known to one of ordinary skill in the art.

A preferred diphenolic epoxy condensation polymer is the following:

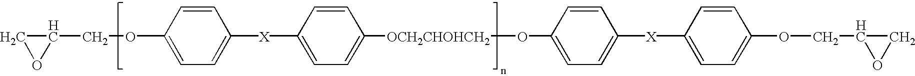

where n=1-16; and

X is —;—C(CH₃)₂—;—SO₂—; —C(CF₃)₂—;—CH₂—;—CO—; or —CCH₃C₂H₅—.

n represents an average and therefore need not be a whole number; X may be the same throughout the polymer or may change throughout the polymer. Preferably, X is —C(CH₃)₂.

Preferred diphenolic epoxy condensation polymers include condensation polymers of epichlorohydrin with a diphenolic compound. Also preferred is a 2,2-bis(p-glycidyloxyphenyl) propane condensation product with 2,2-bis(p-hydroxyphenyl)propane and similar isomers.

Preferred commercially available diphenolic epoxy condensation polymers include the EPON 1000 series of resins (1001F-1009F), available from Shell Chemical Co. Particularly preferred is EPON 1001F.

The epoxy system of my invention also comprises, as a second part of the epoxy system, at least one epoxy compound comprising at least two epoxy groups per molecule of the epoxy compound, more preferably at least three epoxy groups per molecule of the epoxy compound, and more preferably at least four epoxy groups per molecule of the epoxy compound. Even more preferably, an epoxy compound of the second part of the epoxy system comprises between 2 and 4 epoxy groups per molecule of the epoxy compound. The epoxy groups of the epoxy compound preferably comprise glycidyl ethers, and even more preferably, glycidyl ethers of phenolic compounds.

The epoxy compound(s) of the second part of the epoxide system is/are different from the diphenolic epoxy condensation polymers used in the first part of the epoxy system and may be polymeric or non-polymeric. Preferably, the epoxy compound is non-polymeric.

A preferred epoxy compound is EPON 1031 (available from Shell Chemical Co.), which is believed to be primarily a tetraglycidyl ester of tetra (parahydroxyphenyl) ethane.

Preferably, the epoxy system comprises 2 to 30 millequivalents (MEQ) of total epoxy function per 100 g of polyester, with the second part of the epoxy system providing 10 to 75% of the total epoxy function.

More preferably, the epoxy system comprises 3 to 20 millequivalents of total epoxy function per 100 g of polyester, with the second part of the epoxy system providing 20 to 50% of the total epoxy function.

Even more preferably, the epoxy system comprises 4 to 15 millequivalents of total epoxy function per 100 g of polyester, with the second part of the epoxy system providing 20 to 50% of the total epoxy function.

By equivalents herein is meant the number of “moles” of epoxy functional group added.

Optional Conventional Additives

Conventional additives may be added to the polyester compositions of my invention. For instance, a flame retardant and flame-retardant synergist may be added for the purpose of improving flame retardancy, and an antioxidant and heat stabilizer may be added for the purpose of improving heat resistance and preventing discoloration. Other additives include fillers, reinforcing agents, impact modifiers, viscosity modifiers, nucleating agents, colorants and dyes, lubricants, plasticizers, mold-releasing agents, and UV stabilizers.

Polyester compositions of my invention can be obtained by blending all of the component materials using any blending method. These blending components in general are preferably made homogeneous as much as possible. As a specific example, all of the component materials are mixed to homogeneity using a mixer such as a blender, kneader, Banbury mixer, roll extruder, etc. to give a resin composition. Or, part of the materials may be mixed in a mixer, and the rest of the materials may then be added and further mixed until homogeneous. Alternatively, the materials may be dry-blended in advance, and a heated extruder is then used to melt and knead until homogeneous, and then to extrude in a strand shape, followed by cutting to a desirable length to become granulates.

Polyester compositions of my invention may be used alone as molding pellets or mixed with other polymers. The pellets may be used to produce fibers, films, and coatings as well as injection molded or extruded articles, particularly for end use applications where hydrolysis resistance is desired.

Molding of the polyester compositions of my invention into articles can be carried out according to methods known to those skilled in the art. Preferred are generally utilized molding methods such as injection molding, extruding molding, pressing molding, foaming molding, blow molding, vacuum molding, injection blow molding, rotation molding, calendar molding and solution casting molding.

Advantages of my invention, while not a requirement, include increased hydrolysis resistance compared to using only one part of the epoxy system alone at the same level of total epoxy functionality, minimized effects of increased initial melt viscosity, and minimized further increases in melt viscosity during melt processing.

### EXAMPLES

The following Examples 1-15 illustrate preferred embodiments of my invention. My invention is not limited to these examples.

The compositions used in Examples 1-15 contain the following, with all percentages being in weight percent (unless otherwise indicated) as shown below or in the tables:

1. Polybutylene terephthalate (PBT) having an inherent viscosity of 0.79, run at 19 degrees C. at a concentration of 0.40 g PBT/100 ml solution in 1:1 by weight trifluoroacetic acid:methylene chloride.

2. 30% 10 micron diameter glass fibers, PPG 3563 (available from PPG Industries).

3. 0.5% Pentaerythritol Tetrastearate (available from Henkel, Inc.).

4. 0.3% Irganox 1010 (available from Ciba-Geigy).

5. 0.3% black concentrate (carbon black in polyethylene), Americhem 37462 R-1 (available from Americhem, Inc.).

6. One or more epoxy compounds, as indicated, selected from:

a. EPON 1001F (available from Shell Chemical Co.)—an epichlorohydrin/bisphenol A condensation product having an average epoxy equivalent weight (EEW) of 538.

b. EPON 1031 (available from Shell Chemical Co.)—essentially the tetraglycidyl ester of tetra (parahydroxyphenyl) ethane. Its EEW is stated as 212 and its functionality as >3 epoxy groups per molecule.

C. TACTIX 742 (available from Ciba-Geigy)—essentially the tris glycidyl ether of tris (parahydroxyphenyl) methane. Its EEW is stated as 160 and its functionality as about 3.

The polyester compositions were prepared by dry blending all the ingredients, except glass fiber, in a plastic bag, and then compounding the blend on a 28/30 mm Werner and Pfleiderer twin screw extruder, set up in the 30 mm bilobal configuration with vacuum extraction and using a moderately hard-working screw design. Glass fibers were fed into the melt using a loss-in-weight controlled side feeder. Barrel temperatures were set at 270 degrees C. and screw speed was 250 RPM. Extrusion rate was 50 to 60 lbs/hr and melt temperature was 290 to 295 degrees C.

The melt exited a two-hole strand die and was cut into pellets. The pellets were dried for about 16 hours in a desiccated circulating air oven and molded into ⅛″ thick ASTM D638 Type 1 tensile test bars and ⅛″ thick×½″ wide “Flex” bars on a 6 ounce Van Dorn reciprocating screw injection molding machine using a 270 degree C. barrel temperature, 60 RPM screw speed, 80 degree C. mold temperature, and a 30-35 second overall cycle.

Tensile properties were run according to ASTM D 638 at a crosshead speed of 0.2 inch/minute. Elongation was measured using an extensometer.

Notched Izod Impact was run according to ASTM D 256, and Unnotched Impact according to ASTM D 4812, both using ⅛″ thick×1/2″ wide test bars.

Hydrolysis resistance was determined by exposing tensile bars for 100 hours in steam using a pressure cooker at 121 degrees C., which gave a pressure of 14.7 psi gage. The tables below refer to this test as the “PCT” or “pressure cooker test.” The exposed bars were then held at ambient conditions for at least 16 hours and tensile properties were determined as above. Results were compared with those “as molded” to calculate % retention of tensile strength and elongation.

Melt viscosities and melt viscosity stability were run on resin samples that were dried at least 16 hours at 110 degrees C. in a vacuum oven with nitrogen bleed. A Kayeness Galaxy V, Model 8052 constant rate rheometer was used for this purpose. The orifice was 0.040″ in diameter×0.800″ long. The tests were run at 260 degrees C. and a shear rate of 1216 sec⁻¹. Viscosities were measured 5 minutes after the resin had been introduced into the rheometer barrel and also at 10, 15, 20, 25 and 30 minutes (referred to herein as Hold Up Time or simply “HUT”). Melt stabilities were calculated as the ratio of melt viscosities after 20, 25 and 30 minutes to that measured after 5 minutes.

### Examples 1-5

Examples 1-5 were run using ordinary, as polymerized PBT having a carboxylic acid end group content of 37 meq/kg. The data are summarized below in Table A as well as in FIGS. 1 and 2. As shown therein, a combination of EPON 1001F and EPON 1031 gives superior retention of tensile strength and elongation after 100 hours in the pressure cooker test than the use of either epoxy compound alone at the same total level of epoxy content (FIG. 1). Data from a repeat exposure in the pressure cooker show that this test is very consistent. The combination also gives a better balance of low melt viscosity and better melt viscosity stability (FIG. 2).

TABLE A

| | EXAMPLE | | | | |
|---|---|---|---|---|---|
| | 1 | 2 | 3 | 4 | 5 |
| % PBT | 67.0 | 66.2 | 65.5 | 64.9 | 64.2 |
| % EPON 1001F | 0.00 | 1.22 | 2.42 | 3.58 | 4.73 |
| EPON 1001F, MEQ/100 g PBT | 0.00 | 3.43 | 6.87 | 10.25 | 13.69 |
| % EPON 1031 | 1.95 | 1.44 | 0.95 | 0.47 | 0.00 |
| EPON 1031, MEQ/100 g PBT | 13.73 | 10.26 | 6.84 | 3.42 | 0.00 |
| TOTAL EPOXY, MEQ/100 g PBT | 13.73 | 13.69 | 13.71 | 13.67 | 13.69 |
| RUN #1 | | | | | |
| TENSILE STR., KPSI: | | | | | |
| INITIAL | 21.90 | 22.60 | 22.50 | 22.00 | 21.80 |
| 100 HRS PCT | 10.20 | 11.90 | 14.80 | 14.70 | 14.10 |
| % RETENTION | 46.6 | 52.7 | 65.8 | 66.8 | 64.7 |
| % ELONGATION: | | | | | |
| INITIAL | 2.46 | 2.50 | 2.48 | 2.25 | 2.24 |
| 100 HRS PCT | 1.18 | 1.11 | 1.40 | 1.43 | 1.25 |
| % RETENTION | 48.0 | 44.4 | 56.5 | 63.6 | 55.8 |
| RUN #2 | | | | | |
| TENSILE STR., KPSI: | | | | | |
| INITIAL | 21.90 | 22.60 | 22.50 | 22.00 | 21.80 |
| 100 HRS PCT | 10.20 | 11.40 | 14.80 | 14.30 | 13.70 |
| % RETENTION | 46.6 | 50.4 | 65.8 | 65.0 | 62.8 |
| % ELONGATION: | | | | | |
| INITIAL | 2.46 | 2.50 | 2.48 | 2.25 | 2.24 |
| 100 HRS PCT | 1.31 | 1.14 | 1.39 | 1.33 | 1.26 |
| % RETENTION | 53.3 | 45.6 | 56.0 | 59.1 | 56.3 |
| UNNOTCHED IMPACT | 16.2 | 16.6 | 15.8 | 14.6 | 14.5 |
| NOTCHED IZOD | 1.80 | 1.84 | 1.83 | 1.78 | 1.80 |
| MELT VISC. Pa.sec: | | | | | |
| (260° C., 1216 sec-1) | | | | | |
| 5 min HUT | 217 | 222 | 202 | 194 | 193 |
| 10 min | 225 | 227 | 207 | 230 | 256 |
| 15 min | 238 | 234 | 215 | 323 | 423 |
| 20 min | 259 | 269 | 314 | 464 | 647 |
| 25 min | 287 | 294 | 407 | 665 | 773 |
| 30 min | 319 | 478 | 545 | 770 | 837 |
| RATIO 20 MIN/5 MIN | 1.19 | 1.21 | 1.55 | 2.39 | 3.35 |
| RATIO 25 MIN/5 MIN | 1.32 | 1.32 | 2.01 | 3.43 | 4.01 |
| RATIO 30 MIN/5 MIN | 1.47 | 2.15 | 2.70 | 3.97 | 4.34 |

### Examples 6-10

Examples 6-10 are set forth below in Table B. Examples 6 through 9 were run using the same system as Examples 1 through 5, but at a lower total level of epoxy function. Lower total levels of epoxy function give good hydrolysis resistance. Example 10 illustrates the use of a trifunctional glycidyl ether, TACTIX 742, at 50% of the total epoxy content in a mixture with EPON 1001F in ordinary PBT. This experiment is directly comparable, in epoxy function content, to Example 3, but used TACTIX 742 instead of EPON 1031. The results are comparable.

TABLE B

| | EXAMPLE | | | | |
|---|---|---|---|---|---|
| | 6 | 7 | 8 | 9 | 10 |
| % PBT | 67.9 | 68.2 | 67.7 | 67.2 | 65.8 |
| % EPON 1001F | 0.0 | 0.0 | 0.9 | 1.7 | 2.42 |
| EPON 1001F, MEQ/100 g PBT | 0.00 | 0.00 | 2.36 | 4.76 | 6.84 |
| % EPON 1031 | 1.00 | 0.68 | 0.30 | 0.00 | 0.00 |
| EPON 1031, MEQ/100 g PBT | 6.95 | 4.70 | 2.37 | 0.00 | 0.00 |
| % TACTIX 742 | 0.00 | 0.00 | 0.0 | 0.00 | 0.72 |
| TACTIX 742, MEQ/100 g PBT | 0.00 | 0.00 | 0.00 | 0.00 | 6.84 |
| TOTAL EPOXY, MEQ/100 g PBT | 6.95 | 4.70 | 4.73 | 4.76 | 13.68 |
| TENSILE STR., KPSI: | | | | | |
| INITIAL | 22.30 | 22.80 | 22.70 | 23.00 | 22.60 |
| 100 HRS PCT | 12.30 | 9.69 | 9.52 | 9.75 | 15.00 |
| % RETENTION | 55.2 | 42.5 | 41.9 | 42.4 | 66.4 |
| % ELONGATION: | | | | | |
| INITIAL | 2.69 | 2.67 | 2.62 | 2.62 | 2.51 |
| 100 HRS PCT | 1.48 | 1.04 | 1.04 | 1.06 | 1.43 |
| % RETENTION | 55.0 | 39.0 | 39.7 | 40.5 | 57.0 |
| SP. GRAVITY | | | | | |
| UNNOTCHED IZOD | 20.00 | 20.70 | 19.70 | 18.80 | 16.1 |
| NOTCHED IZOD | 1.90 | 1.81 | 1.75 | 1.81 | 1.86 |
| MELT VISC. Pa.sec: | | | | | |
| (260° C., 1216 sec-1) | | | | | |
| 5 min HUT | 257 | 261 | 223 | 215 | 194 |
| 10 min | 255 | 259 | 221 | 225 | 213 |
| 15 min | 250 | 258 | 224 | 274 | 257 |
| 20 min | 268 | 266 | 235 | 326 | 333 |
| 25 min | 297 | 291 | 267 | 426 | 507 |
| 30 min | 317 | 292 | 289 | 476 | 639 |
| RATIO 20 MIN/5 MIN | 1.04 | 1.02 | 1.05 | 1.52 | 1.72 |
| RATIO 25 MIN/5 MIN | 1.16 | 1.11 | 1.20 | 1.98 | 2.61 |
| RATIO 30 MIN/5 MIN | 1.23 | 1.12 | 1.30 | 2.21 | 3.29 |

### Examples 11-15

Examples 11-15 are set forth below in Table C. These examples were prepared using PBT that was polymerized to an intrinsic viscosity (I.V.) of 0.60 and then solid state polymerized to an I.V. of 0.79. This yielded a resin having a carboxylic acid end group concentration of only about 7 meq/kg. Using the lower acid content PBT gives better hydrolysis resistance than Examples 7 to 9, which use the same epoxy level but with ordinary PBT. Hydrolysis resistance is improved using 25% to 75% of the total epoxy function from EPON 1031 than from either EPON 1031 or EPON 1001F alone. It is believed that there are no significant differences in melt viscosity or viscosity stability, because of the low acid content in the PBT.

TABLE C

| | EXAMPLE | | | | |
|---|---|---|---|---|---|
| | 11 | 12 | 13 | 14 | 15 |
| % PBT | 67.2 | 67.4 | 67.7 | 68 | 68.2 |
| % EPON 1001F | 1.72 | 1.29 | 0.86 | 0.43 | 0.00 |
| EPON 1001F, MEQ/100 g PBT | 4.76 | 3.56 | 2.36 | 1.18 | 0.00 |
| % EPON 1031 | 0.00 | 0.17 | 0.34 | 0.51 | 0.68 |
| EPON 1031, MEQ/100 g PBT | 0.00 | 1.19 | 2.37 | 3.54 | 4.70 |
| TOTAL EPOXY, MEQ/100 g PBT | 4.76 | 4.75 | 4.73 | 4.72 | 4.70 |
| TENSILE STR., KPSI: | | | | | |
| INITIAL | 22.20 | 22.50 | 22.60 | 22.40 | 22.10 |
| 100 HRS PCT | 12.60 | 12.80 | 13.10 | 12.50 | 11.70 |
| % RETENTION | 56.8 | 56.9 | 58.0 | 55.8 | 52.9 |
| % ELONGATION: | | | | | |
| INITIAL | 2.70 | 2.53 | 2.64 | 2.57 | 2.66 |
| 100 HRS PCT | 1.03 | 1.09 | 1.18 | 1.16 | 1.09 |
| % RETENTION | 38.1 | 43.1 | 44.7 | 45.1 | 41.0 |
| UNNOTCHED IZOD | 17.7 | 17.7 | 17.6 | 18.1 | 18.4 |
| NOTCHED IZOD | 1.68 | 1.78 | 1.82 | 1.77 | 1.81 |
| MELT VISC. Pa.sec: | | | | | |
| (260° C., 1216 sec-1) | | | | | |
| 5 min HUT | 179 | 182 | 194 | 192 | 198 |
| 10 min | 163 | 167 | 178 | 179 | 186 |
| 15 min | 157 | 159 | 169 | 172 | 182 |
| 20 min | 151 | 157 | 170 | 170 | 180 |
| 25 min | 152 | 151 | 177 | 165 | 188 |
| 30 min | 161 | 160 | 186 | 165 | 178 |
| RATIO 20 MIN/5 MN | 0.84 | 0.86 | 0.88 | 0.89 | 0.91 |
| RATIO 25 MIN/5 MN | 0.85 | 0.83 | 0.91 | 0.86 | 0.95 |
| RATIO 30 MIN/5 MN | 0.90 | 0.88 | 0.96 | 0.86 | 0.90 |

While this invention has been described with respect to what is at present considered to be the preferred embodiments, it is to be understood that my invention is not limited to the disclosed embodiments. To the contrary, my invention is intended to cover various modifications and equivalent arrangements included within the spirit and scope of the appended claims. The scope of the following claims is to be accorded the broadest interpretation so as to encompass all such modifications and equivalent formulations and functions.

What is claimed is:

1. Polyester composition comprising:
(a) at least one polyester; and
(b) an epoxy system comprising
(i) diphenolic epoxy condensation polymer; and
(ii) at least one epoxy compound comprising at least two epoxy groups per molecule of said at least one epoxy compound.

2. The polyester composition of claim 1, wherein said epoxy groups of said at least one epoxy compound comprise glycidyl ethers of phenolic compounds.

3. The polyester composition of claim 1, wherein said epoxy system has a total epoxy function of 2 to 30 milliequivalents per 100 grams of said at least one polyester.

4. The polyester composition of claim 3, wherein component (b)(ii) comprises between 10 and 75 percent of said total epoxy function.

5. The polyester composition of claim 4, wherein component (b)(ii) comprises one epoxy compound.

6. The polyester composition of claim 1, wherein said at least one epoxy compound comprises at least three epoxy groups per molecule of said at least one epoxy compound.

7. The polyester composition of claim 1, wherein said at least one epoxy compound comprises at least four epoxy groups per molecule of said at least one epoxy compound.

8. The polyester composition of claim 7, wherein said epoxy groups of said at least one epoxy compound comprise glycidyl ethers of phenolic compounds.

9. The polyester composition of claim 8, wherein said epoxy system has a total epoxy function of 2 to 30 milliequivalents per 100 grams of said at least one polyester.

10. The polyester composition of claim 9, wherein component (b)(ii) comprises between 10 and 75 percent of said total epoxy function.

11. The polyester composition of claim 10, wherein component (b)(ii) comprises one epoxy compound.
